(19) United States
(12) Patent Application Publication
(10) Pub. No.: US 2009/0230799 A1
(43) Pub. Date: Sep. 17, 2009

(54) Fixing strcture of motor spindle

(75) Inventors: Alex Horng, Kaohsiung City (TW); Shih-Chang Huang, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Sunonwealth Electric Machine Industry Co., Ltd., Kaohsiung City (TW)

(21) Appl. No.: 12/081,422

(22) Filed: Apr. 16, 2008

(30) Foreign Application Priority Data
Mar. 13, 2008 (TW) 97108796

(51) Int. Cl. H02K 5/167; H02K 1/12; H02K 7/08; H02K 1/22

(52) U.S. Cl. 310/90; 310/66

(57) ABSTRACT

The present invention relates to a fixing structure of motor spindle, which includes a spindle and a snap ring. One end of the spindle has a snap slot with a reduced diameter, and the inner hole of the snap ring shall be slightly greater than the maximum outer diameter of the snap slot, thereby maintaining a gap with a radius difference between the inner hole of the snap ring and the snap slot of the spindle in size of less than or equivalent to 0.37 mm. Meanwhile, by means of the holding effect of a bearing and a bottom cap, the snap ring of the present invention won't rotate with the spindle and won't generate noise due to abrasion with the spindle. Not only can the snap ring stably hold and fix the spindle to prevent the spindle from disengaging, but also it is free of the noise issue out of abrasion.

### FIELD OF THE INVENTION

The present invention relates to a fixing structure of motor spindle, and more particularly to a practical structure capable of preventing a snap ring from disengaging and avoiding to generate noise out of abrasion.

### BACKGROUND OF THE INVENTION

As shown in FIG. 1, a motor structure applied in a cooling fan includes a stator 10 and a rotor 20, in which the stator 10 is fixedly disposed on a shaft tube seat 30, a shaft tube 31 is centrally fixed in the shaft tube seat 30, a bearing 32 is disposed inside the shaft tube 31, the rotor 20 is integrally combined and fixed with a hub 21, the hub 21 caps and envelops the stator 10 so that an air gap is exactly maintained between the rotor 20 and the stator 10 and correspondingly located over an inner side of the stator 10.

Moreover, a spindle 22 is centrally disposed in the hub 21; after being inserted in an oil seal 33 and a gasket 34, the spindle 33 can then pass through the bore of the bearing 32; an outer end of the spindle 22 stretching beyond the bearing 32 sequentially penetrate through an oil seal 35, a washer 36 and a gasket 37, and a snap ring 41 is fixedly retained in a snap slot on the end portion of the spindle 22; lastly, an end cap 38 is used to fully seal the bottom portion of the shaft tube 31.

Together with the illustration of FIG. 2, when the snap ring 41 of the conventional structure is fixedly retained in the snap slot 23 on the end portion of the spindle 22, the outer diameter of the snap slot is greater than the inner diameter of the snap ring 41 and the outer diameter of the spindle 22 is greater than the outer diameter of the snap slot 23 so that a seamless and tight fitting is present between the snap ring 41 and the snap slot 23 and easily results in deformation of the entire snap ring 41 and functional loss of the snap ring 41. As a result, when the spindle 22 is rotating, the snap ring surely rotates with the spindle 22, making that the snap ring 41 collides with the oil seal 35, the washer 36, the gasket 37 and so on to generate noise. Meanwhile, the snap ring 41 is positioned in an unstably rotating condition for long while and is easier to disengage from the snap slot 23.

### SUMMARY OF THE INVENTION

The main object of the present invention is to provide a fixing structure of motor spindle, which maintains a gap between the hole of a snap ring and an outer diameter of the snap slot to prevent the snap ring from rotating with the spindle in generation of noise out of abrasion and from disengaging.

The fixing structure of motor spindle of the present invention includes a spindle whose one end has a snap slot with a smaller outer diameter; a snap ring retained in the snap slot on the spindle whose inner hole is slightly larger than the maximum outer diameter of the snap slot on the spindle, so that a gap being the difference of radii thereof is maintained in size of less than or equivalent to 0.37 mm between the hole of the snap ring and the snap slot of the spindle.

Therefore, when an end of the spindle is pushed in the snap ring, it is easily retained by the snap ring without giving rise to deformation of the snap ring. At the same time, the rotor is stably positioned to rotate, getting rid off the requirement of oil ring, washer and gasket. Besides, when the spindle is rotating, the snap ring of the present invention won't rotate with the spindle as a result of the holding effect of a bearing and a bottom cap, not only stably holding and fixing the spindle to prevent it from disengaging but also generating no issue of noise out of abrasion for sake of attainting the demand for cost reduction and reliable quality.

### BRIEF DESCRIPTION OF THE DRAWINGS

FIG. 1 is a cross-sectional view showing a conventional structure;

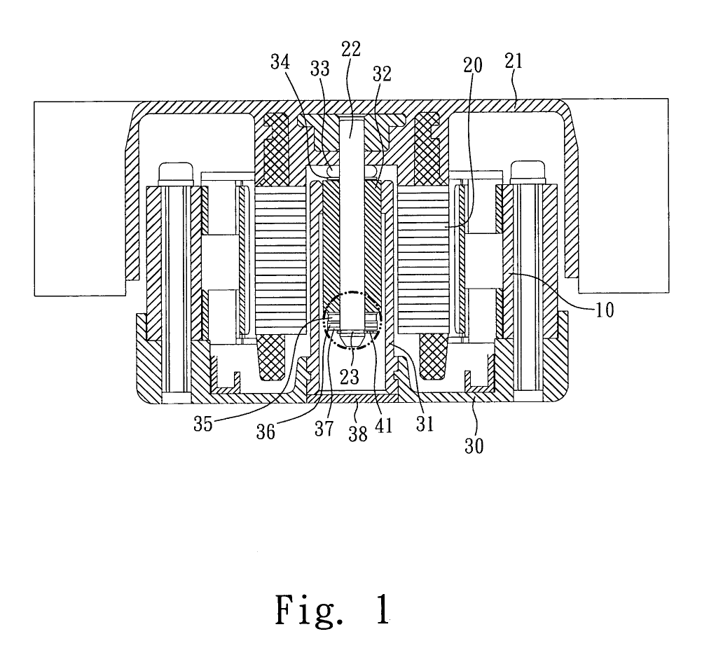

FIG. 2 is a partially enlarged schematic view showing a conventional structure;

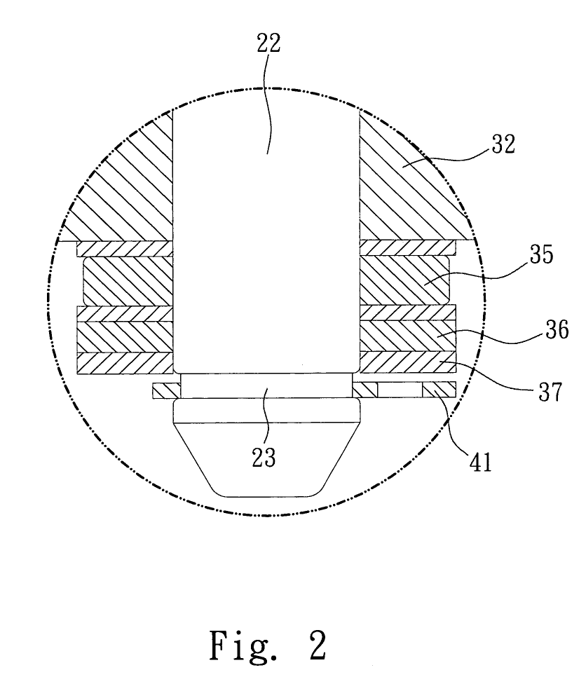

FIG. 3 is a cross-sectional view of the present invention; and

FIG. 4 is a partially enlarged view of the present invention.

### DETAILED DESCRIPTION OF THE PREFERRED EMBODIMENT

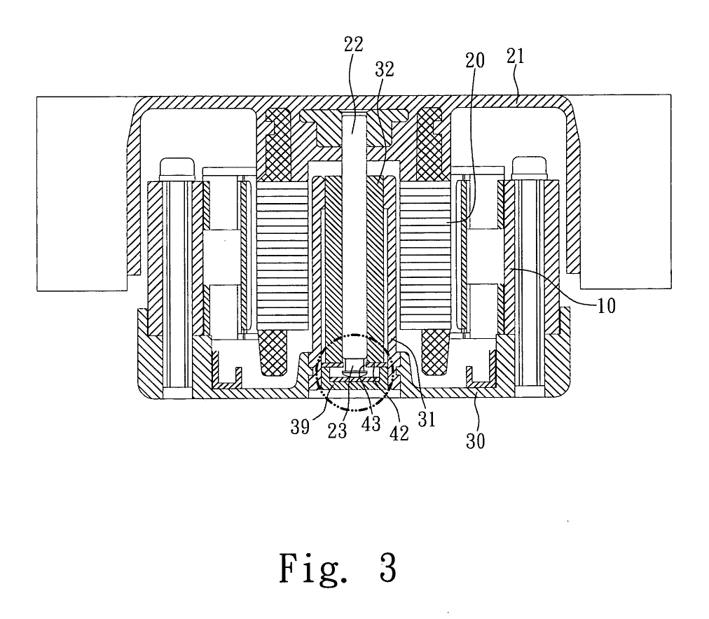

The present invention relates to a fixing structure of motor spindle, as shown in FIG. 3, which includes a stator 10 fixedly disposed on a shaft tube seat 30, in which a shaft tube 31 is centrally fixed in the shaft tube seat 30 and a bearing 32 is disposed inside the shaft tube 31, a rotor 20 integrally combined and fixed with a hub 21, in which the hub 21 can cap and envelop the stator 10 and an air gap is maintained between the rotor 20 and the stator 10.

Moreover, the hub 21 has a spindle 22 centrally; an outer end of the spindle 22 has a snap slot 23 with a reduced outer diameter; after the spindle passes through the bore of the bearing 22, a snap ring 42 is used to hold and position the snap slot 23 of its end portion; lastly, the bottom portion of the shaft tube 31 is sealed with a bottom cap 39.

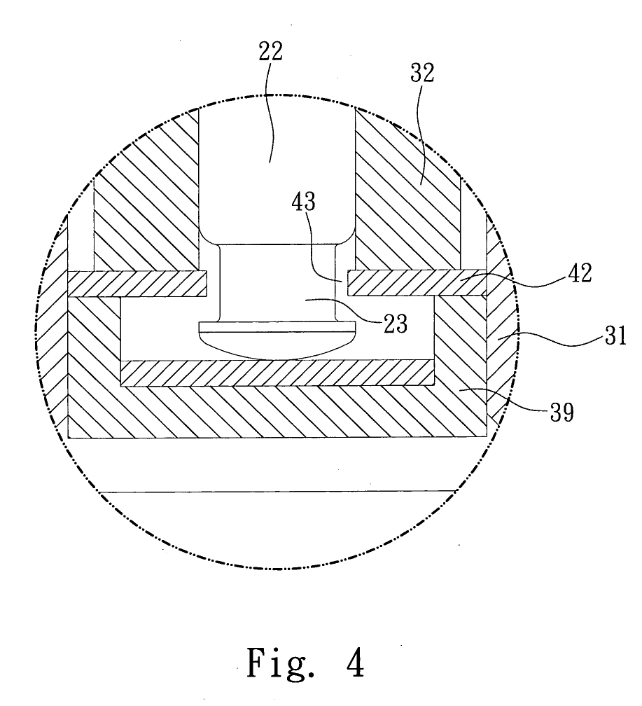

Further in combination with the illustration of FIG. 4, the inner hole of the snap ring 42 shall be slightly greater than the maximum outer diameter of the snap slot 23 on the spindle 22 in the present invention. After the snap ring 42 is retained in the snap slot 23, a gap of the radius difference for the inner hole of the snap ring 42 and the snap slot in size of less than or equivalent to 0.37 mm is reserved.

In view of a gap 43 maintained between the inner hole of the snap ring 42 and the outer diameter of the snap slot 23 in the present invention and the periphery of the snap ring 42 held and fixed by the bearing 32 and the bottom cap 39, the rotor 20 held and positioned by the snap ring 42 won't require additional oil seal, washer and gasket. When the spindle 22 is rotating, the snap ring 42 of the present invention won't rotate with the spindle 22, won't generate noise due to abrasion with the spindle 22 either and is free of the deformation concern of the snap ring 42.

In sum, not only can the snap ring 42 of the present invention stably hold and position the spindle 22 to prevent from disengaging, but also it is free of the issue of noise out of abrasion and the mounting of oil seal, washer and gasket. From the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the circular disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A fixing structure of motor spindle, comprising:
a spindle having a snap slot with a reduced outer diameter at one end thereof; and
a snap ring having an inner diameter slightly greater than an outer diameter of the snap slot on the spindle and retained in the snap slot to maintain a gap with a radius difference between an inner hole of the snap ring and the snap slot in size of less than or equivalent to 0.37 mm.

2. The fixing structure of motor spindle as set forth in claim 1, wherein the spindle is received in a shaft tube, the shaft tube is centrally fixed in a shaft tube seat, and a stator is fixed on the shaft tube seat.

3. The fixing structure of motor spindle as set forth in claim 2, wherein a bearing is disposed in the shaft tube for supporting the spindle to rotate.

4. The fixing structure of motor spindle as set forth in claim 2, wherein one end of the spindle is centrally fixed in a hub, and a rotor is disposed on the hub to correspond to the stator.
